(19) United States
(12) Patent Application Publication
(10) Pub. No.: US 2008/0259011 A1
(43) Pub. Date: Oct. 23, 2008

(54) IMAGE OUTPUT APPARATUS AND IMAGE DISPLAY APPARATUS

(75) Inventor: Naoki HAYASHI, Kanagawa (JP)

Correspondence Address: YOUNG & THOMPSON, 209 Madison Street, Suite 500, ALEXANDRIA, VA, 22314, US

(73) Assignee: NEC ELECTRONICS CORPORATION, KANAGAWA (JP)

(21) Appl. No.: 12/104,835

(22) Filed: Apr. 17, 2008

(30) Foreign Application Priority Data
Apr. 17, 2007 (JP) 2007-107767

(51) Int. Cl. G09G 3/36

(52) U.S. Cl. 345/87

(57) ABSTRACT

A video display device outputs display device information including physical resolution of a display device included in the video display device and subpixel information to a hard disk recorder through HDMI (High Definition Multimedia Interface) cable. A receiver of the hard disk recorder receives the display device information and outputs the received information to an image processor. The image processor converts resolution of an image data stored in HD into physical resolution of the display device included in the display device information to output the image data. The image processor performs processing in subpixel level based on the subpixel information included in the display device information in converting the resolution.

### BACKGROUND OF THE INVENTION

1. Field of the Invention

The present invention relates to an image processing technique, and more specifically, to an image processing technique to output image to an image display apparatus where one pixel is composed of a plurality of subpixels.

2. Description of Related Art

Image display devices using various image display devices have now been used. In some image display devices such as color LCD, color plasma display, or color organic EL panel, for example, light-emitting elements emitting each of three primary colors of RGB are arranged in a fixed order to compose one pixel. These light-emitting elements are typically called subpixels. The subpixels are arranged in stripe arrangement, delta arrangement, or diagonal arrangement in the image device, for example. Even among the stripe arrangement, the arrangement order of the subpixels may be different like RGB or BRG depending on the image display apparatus. The shape of the subpixels is not limited to rectangle or round shape but may be L shape or the like.

Some image display apparatuses use magenta and so on as auxiliary color in addition to the three primary colors of RGB and include subpixels of these auxiliary colors in the subpixels. Further, the unit of the pixel may be one pixel unit or a plurality of pixel units. One pixel unit composes one pixel by three subpixels of RGB, for example. A plurality of pixel units compose two pixels by five subpixels of RGBGR, for example.

The information indicating a form of composing the pixel by subpixels, type, arrangement order, shape, or size of the subpixels is hereinafter called subpixel information.

When the image (including font) is displayed on the image display apparatus, various image processings may be performed in order to display the image with high quality. Some of the image processings may be performed in subpixel level rather than in pixel level in order to obtain the image with higher quality. The processing in subpixel level means the processing in accordance with the subpixel information stated above. The processing in pixel level is performed based on the assumption that the pixel is formed in one pixel unit where one pixel is composed of only three subpixels of RGB, which means that the processing is performed such that each subpixel in the pixel is superimposed and central coordinates of each subpixel are apparently the same.

Japanese Patent Translation Publication No. 2006-146179 (Abe et al.) discloses a technique to change arrangement order of the subpixels of the input image to the arrangement order of the subpixels of its own when the arrangement order of the subpixels of the input image is different from the arrangement order of the subpixels of its own. By this technique, it is possible to solve the problem such as coloring generated at edge part or oblique line being jaggy when the image is displayed where arrangement order of the subpixels is different from the arrangement order of its own.

Japanese Patent Translation Publication No. 2002-40985 (Tezuka et al.) discloses the image display apparatus where three subpixels of RGB are aligned in a fixed order to compose one pixel. In the image display apparatus, the input image data is converted into working image data by reducing the input image data by 3/n in a vertical scanning direction in changing the resolution of the input image to reduce the input image by 1/n. The working image data is then allocated to the three subpixels composing one pixel. According to the image display apparatus, it is possible to prevent a part of the image being reduced even when the size of the input image is reduced for display in the image display apparatus where the pixel is formed in one pixel unit and three subpixels (RGB) composing each pixel are aligned in a vertical scanning direction.

Japanese Patent Translation Publication No. 2003-512653 (Ghuloum et al.) discloses a technique used in an image display apparatus determining a feature (edge or the like) of an input image, generating a subpixel correction signal based on the determined feature and the attribute of the image display apparatus, and using the generated subpixel correction signal to generate a pixel drive signal. The attribute of the image display apparatus which is mentioned here corresponds to the above-described subpixel information. The image display apparatus performs rendering in subpixel level. It is possible to maintain the feature of the image by using the subpixel information and to display the input image with high quality.

Japanese Patent Translation Publication No. 2002-543473 (Charlton et al.) discloses a technique to perform rendering process on a text displayed on an image display apparatus. By performing rendering process in subpixels when the text is displayed on the image display apparatus, it is possible to display the outline of the font more clearly. Note that this technique is used in the image display apparatus having subpixels aligned in horizontal striping.

As stated above, various image processings are performed in subpixel level in order to improve the quality in displaying the image.

However, we have now discovered that there are problems in the related arts as follows. The techniques disclosed in Abe et al, Tezuka et al, and Ghuloum et al are applied to the case where the image display apparatus itself performs the image processing after the image is input to the image display apparatus. They cannot be applied to the case where the image processing needs to be performed when the image data is input to the image display apparatus.

For example, HDMI (High Definition Multimedia Interface) has recently been attracted as a standard for AV (Audio Video, Audio Visual) consumer electronics. For example, data obtained by recording the video of terrestrial digital high-definition broadcasting using a hard disk recorder in accordance with the HDMI is output to the image display apparatus such as a TV monitor or the like. Now, if the resolution of the recorded video and the resolution that can be handled by the image display apparatus are different, the resolution needs to be converted in the hard disk recorder side. In the HDMI, it is not set that the image display apparatus provides subpixel information of the image display device included in the image display apparatus for the image output apparatus of the hard disk recorder connected to the image display apparatus. Therefore, resolution cannot be converted in subpixel level depending on the subpixel information of the display device in the hard disk recorder side, which possibly causes degradation of the quality of the image due to resolution conversion.

In the technique disclosed in Charlton et al., when rendering process is performed on the text image output to the image display apparatus, this processing is only performed assuming the subpixel information of the image display apparatus in the image display apparatus. Therefore when the subpixel information of the image display apparatus is different from the predetermined one, the quality of the image can further be deteriorated.

### SUMMARY

According to one aspect of the present invention, there is provided an image output apparatus. The image output apparatus outputs an image to an image display apparatus including an image display device where one pixel is composed of a plurality of subpixels, and includes a display device information acquisition part acquiring display device information including subpixel information indicating information regarding subpixels composing the pixel in the image display device, an image processor performing image processing in subpixel level on the image output to the image display apparatus based on the subpixel information acquired by the display device information acquisition part, and an output part outputting the image processed by the image processor to the image display apparatus.

According to another aspect of the present invention, there is provided an image display apparatus. The image display apparatus includes an image display device where one pixel is composed of a plurality of subpixels, and further includes a display device information output outputting display device information including subpixel information indicating information regarding subpixels composing the pixel in the image display device to an external image output apparatus, and a receiver receiving image data from the image output apparatus.

Even when the image output apparatus or the image display apparatus of the above aspects is replaced with the method, system or program, it is still effective as the aspects of the present invention.

According to the technique of the present invention, it is possible to perform image processing in subpixel level on the image when the image is output to the image display apparatus.

### BRIEF DESCRIPTION OF THE DRAWINGS

The above and other objects, advantages and features of the present invention will be more apparent from the following description of certain preferred embodiments taken in conjunction with the accompanying drawings, in which:

FIG. 1 shows a video transmission system according to a first embodiment of the present invention;

FIG. 2 shows a hard disk recorder in the video transmission system shown in FIG. 1;

FIG. 3 shows a video display device in the video transmission system shown in FIG. 1; and

FIG. 4 shows an image processing system according to a second embodiment of the present invention.

### DETAILED DESCRIPTION OF PREFERRED EMBODIMENTS

The invention will now be described herein with reference to illustrative embodiments. Those skilled in the art will recognize that many alternative embodiments can be accomplished using the teachings of the present invention and that the invention is not limited to the embodiments illustrated for explanatory purposes.

### First Embodiment

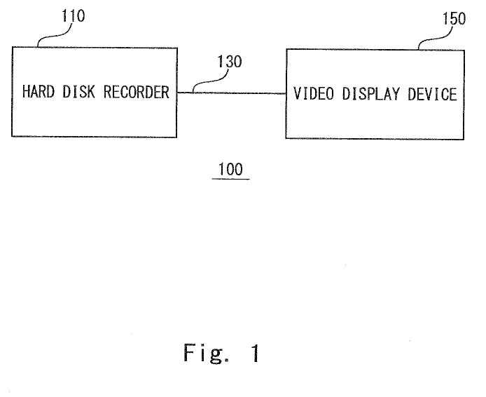

FIG. 1 shows a video transmission system 100 according to the first embodiment of the present invention. The video transmission system 100 includes a hard disk recorder 110 recording video of digital broadcasting and a video display device 150 displaying video data output from the hard disk recorder 110. The hard disk recorder 110 and the video display device 150 are connected to each other by a cable (hereinafter referred to as HDMI cable) 130 in accordance with HDMI standard.

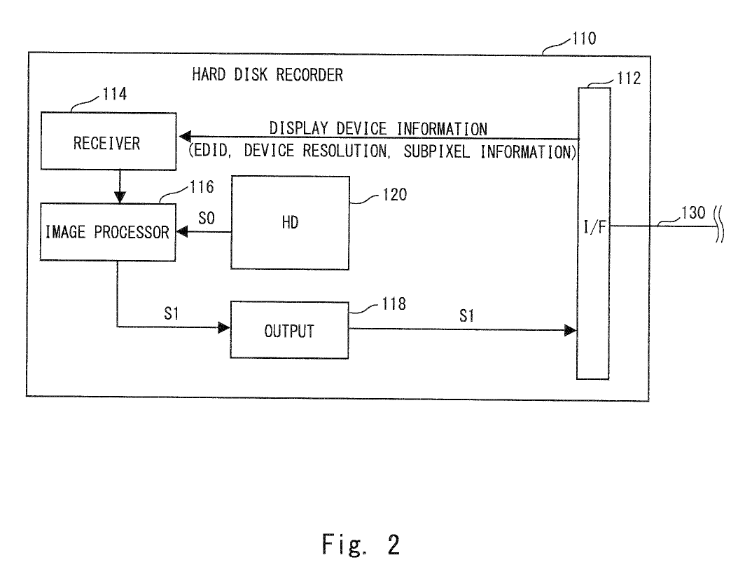

FIG. 2 shows a configuration of the hard disk recorder 110. The hard disk recorder 110 includes an interface (hereinafter referred to as I/F) 112, a receiver 114, a hard disk (hereinafter referred to as HD) 120, an image processor 116, and an output 118.

The I/F 112 is connected to the HDMI cable 130 and transmits and receives data between the hard disk recorder 110 and the video display device 150. The receiver 114 receives display device information that is transmitted from the video display device 150 through the I/F 112. The HD 120 stores video data S0 obtained by recording. The image processor 116 performs image processing on the video data S0 stored in the HD 120 based on the display device information received by the receiver 114 and generates the output video data S1. The output 118 has a function of outputting the output video data S1 that is obtained by the image processor 116 to the HDMI cable 130 through the I/F 112.

The video data S0 stored in the HD 120 of the hard disk recorder 110 is the video data of terrestrial digital high-definition broadcasting, for example. The video data S0 has resolution of 1080 pixels in a vertical direction*1440 pixels in a horizontal direction.

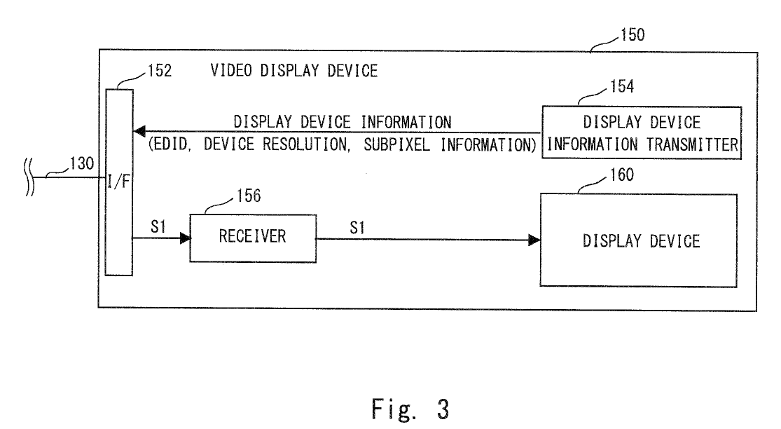

FIG. 3 shows a configuration of the video display device 150. The video display device 150 includes an interface (hereinafter referred to as I/F) 152, a display device information transmitter 154, a receiver 156, and a display device 160. The I/F 152 is connected to the HDMI cable 130 to transmit and receive data between the hard disk recorder 110 and the video display device 150. The display device information transmitter 154 transmits display device information to the hard disk recorder 110 through I/F 152. The receiver 156 receives the output video data S1 output from the hard disk recorder 110. The display device 160 displays the output video data S1 received by the receiver 156.

Now, the display device information transmitted to the hard disk recorder 110 by the video display device 150 will be described. In the HDMI-based system, the video display device typically outputs information called EDID (Extended Display Identification Data) to the device that is connected to the video display device when the power is turned on or connector is reconnected. This EDID includes the information such as the model name of the video display device or set value of each part or the like and also includes resolution that can be handled by the video display device. The resolution that can be handled by the video display device means the resolution that can be processed by the video display device and often includes physical resolution of the display device included in the video display device. However, the resolution that can be handled by the video display device also includes other resolution than the physical resolution of the display device. When the input image data has the resolution that can be handled by the video display device and is different from the physical resolution of the display device, the video display device converts the resolution of this image data into the physical resolution of the display device so as to display the image on the display device.

Hereinafter, the resolution that can be handled by the video display device is called “display device resolution” and the physical resolution of the device is called “device resolution”. Now, as an example, the display device 160 has the device resolution of 720 pixels in a vertical direction×1280 pixels in a horizontal direction.

In the video transmission system 100 of the present embodiment, the display device information transmitter 154 of the video display device 150 outputs the device resolution of the display device 160 and the subpixel information with the EDID as the display device information to the HDMI cable 130 through the I/F 152. The subpixel information includes type and arrangement order of subpixels composing the pixel, geometric form of the subpixels, size of the subpixels, and unit when the subpixels compose the pixel.

The receiver 114 of the hard disk recorder 110 receives the display device information output from the video display device 150 to the HDMI cable 130 through the I/F 112 and outputs the display device information to the image processor 116.

The image processor 116 reads out the video data S0 stored in the HD 120, converts the resolution of the video data S0 into the device resolution of the video display device 150, and obtains the output video data S1. As stated above, the video data S0 has resolution of 1080 pixels in a vertical direction×1440 pixels in a horizontal direction and the video display device 150 has device resolution of 720 pixels in a vertical direction×1280 pixels in a horizontal direction. Therefore, the image processor 116 reduces the resolution of the video data S0 to have resolution of 720 pixels×1280 pixels. When the resolution is reduced, the image processor 116 performs processing in subpixel level by referring to the subpixel information of the display device 160 included in the display device information.

The image processor 116 outputs the output video data S1 obtained by reducing the video data S0 to the output 118 and the output 118 outputs the output video data S1 to the HDMI cable 130 through the I/F 112.

The resolution of the output video data S1 output from the hard disk recorder 110 to the HDMI cable 130 is the same as the device resolution of the video display device 150. Therefore, the receiver 156 of the video display device 150 receives the output video data S1 output from the hard disk recorder 110 to the HDMI cable 130 through the I/F 152 to directly output the output video data S1 to the display device 160 where the data is displayed.

As stated above, according to the video transmission system 100 of the present embodiment, the video display device 150 side transmits the device resolution of the display device 160 and the subpixel information to the hard disk recorder 110, and the hard disk recorder 110 side outputting the image performs resolution converting process in subpixel level on the video data S0 in order to output the output video data S1 having the same resolution as the device resolution of the display device 160.

Now, the related video transmission systems and the present invention will be compared with each other. In the related video transmission systems, the display device resolution is provided to the video output device side outputting the video data to the video display device. However, the device resolution is not provided. Therefore, the resolution of the video data is converted into one resolution of the display device resolution to output the video data. The resolution of the output video data obtained by converting the resolution is not always the same as the device resolution of the video display device. Therefore, resolution of the output video data that is received may need to be converted into the device resolution in the video display device side. Such two converts of the resolution may cause degradation of the quality of the image. On the other hand, in the video transmission system 100 of the present embodiment, the resolution of the video data is directly converted into the device resolution of the video display device, which means the converting of the resolution needs to be performed only once. Therefore, it is possible to prevent the image from being degraded. Further, when the resolution is converted, the process is performed in the subpixel level by referring to the subpixel information of the display device, thereby making it possible to prevent image from being degraded such as a part of the image being reduced or edge being blurred.

### Second Embodiment

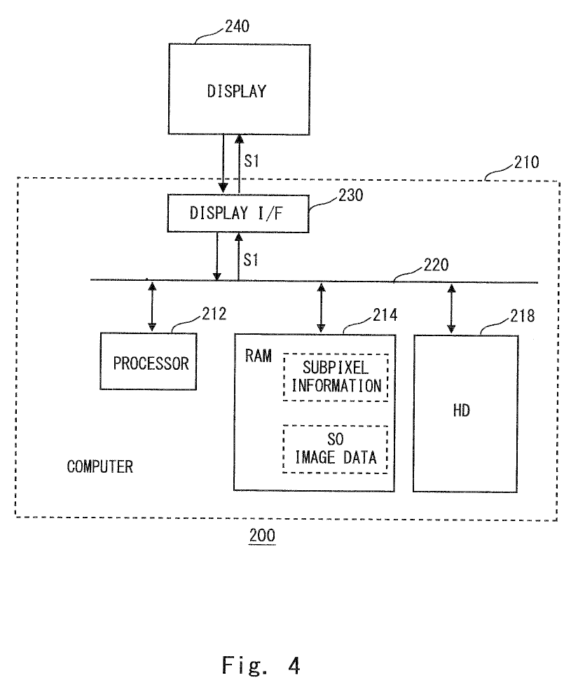

FIG. 4 shows an image processing system 200 according to the second embodiment of the present invention. The image processing system 200 includes a computer 210 and a display 240. The computer 210 includes a processor 212, an RAM (Random Access Memory) 214, a hard disk (hereinafter referred to as HD) 218, and a display interface (hereinafter referred to as display I/F) 230. Each of these function blocks are connected by a system bus 220. The description is made only on the parts related to the present invention and other functions that are typically included in a computer are neither described nor shown.

The HD 218 stores OS (Operating System), various programs, and data to operate the processor 212. In operating the computer 210, the OS, the program, and the data are loaded into the RAM 214. The processor 212 processes the data by executing the program loaded into the RAM 214.

The processor 212 executes the rendering program loaded into the RAM 214. For example, the processor 212 performs rendering process on the image data S0 which is the font data to obtain the output image data S1. The image data S0 may be the one read out from the HD 218, the one read out from the portable media which is not shown, or the one transmitted through network.

The output image data S1 is output from the RAM 214 to the display I/F 230 through the system bus 220 to be output to the display 240 from the display I/F 230.

In the present embodiment, the display 240 outputs the subpixel information of its own to the computer 210 when the power is turned on or connector is reconnected. In the computer 210 side, the subpixel information of the display 240 received through the display I/F 230 is stored in the RAM 214. The processor 212 performs rendering process in subpixel level by referring to the subpixel information of the display 240 when rendering process is performed on the image data S0 so as to obtain the output image data S1.

In the image processing system 200 of the present embodiment, the processor 212 functioning as the image processor and the rendering program can perform rendering process in subpixel level by providing the subpixel information to the computer 210 by the display 240, thereby making it possible to display the font data or the like on the display 240 with high quality.

It is apparent that the present invention is not limited to the above embodiment, but may be modified and changed without departing from the scope and spirit of the invention.

For example, in the video transmission system 100 shown in FIG. 1, the video display device 150 transmits the device resolution in addition to the EDID. However, the video display device 150 may transmit the information indicating which one of the display device resolution included in the EDID is the device information.

1. An, image output apparatus outputting an image to an image display apparatus including an image display device where one pixel is composed of a plurality of subpixels, the image output unit comprising:
a display device information acquisition part acquiring display device information including subpixel information indicating information regarding subpixels composing the pixel in the image display device;
an image processor performing image processing in subpixel level on the image output to the image display apparatus based on the subpixel information acquired by the display device information acquisition part; and
an output part outputting the image processed by the image processor to the image display apparatus.

2. The image output apparatus according to claim 1, wherein the subpixel information includes type and arrangement order of the subpixels composing the pixel.

3. The image output apparatus according to claim 1, wherein the subpixel information includes geometric form of the subpixels composing the pixel.

4. The image output apparatus according to claim 2, wherein the subpixel information includes geometric form of the subpixels composing the pixel.

5. The image output apparatus according to claim 1, wherein the subpixel information includes size of the subpixels composing the pixel.

6. The image output apparatus according to claim 2, wherein the subpixel information includes size of the subpixels composing the pixel.

7. The image output apparatus according to claim 1, wherein the subpixel information includes unit when the subpixel composes the pixel.

8. The image output apparatus according to claim 2, wherein the subpixel information includes unit when the subpixel composes the pixel.

9. The image output apparatus according to claim 1, wherein the display device information acquisition part further acquires device resolution indicating physical resolution of the image display device, and
the image processor converts resolution of the image output to the image display apparatus into the device resolution based on the subpixel information acquired by the display device information acquisition part.

10. The image output apparatus according to claim 2, wherein the display device information acquisition part further acquires device resolution indicating physical resolution of the image display device, and
the image processor converts resolution of the image output to the image display apparatus into the device resolution based on the subpixel information acquired by the display device information acquisition part.

11. The image output apparatus according to claim 10, wherein the image output apparatus complies with HDMI (High-Definition Multimedia Interface) standard and is connected to the image display apparatus by HDMI cable.

12. The image output apparatus according to claim 1, wherein the image processor performs rendering process on the image output to the image display apparatus.

13. The image output apparatus according to claim 2, wherein the image processor performs rendering process on the image output to the image display apparatus.

14. An image display apparatus comprising:
an image display device where one pixel is composed of a plurality of subpixels;
a display device information output outputting display device information including subpixel information indicating information regarding subpixels composing the pixel in the image display device to an external image output apparatus; and
a receiver receiving image data from the image output apparatus.

15. The image display apparatus according to claim 14, wherein the display device information output further obtains device resolution indicating physical resolution of the image display apparatus.

16. The image display apparatus according to claim 14, wherein the image display apparatus complies with HDMI (High-Definition Multimedia Interface) standard and is connected to the image output apparatus through HDMI cable.

17. The image display apparatus according to claim 15, wherein the image display apparatus complies with HDMI (High-Definition Multimedia Interface) standard and is connected to the image output apparatus through HDMI cable.
